(19) United States
(12) Patent Application Publication
(10) Pub. No.: US 2026/0217533 A1
(43) Pub. Date: Jul. 30, 2026

(54) PROCESS FOR PRODUCING VERY HIGH PURITY HELIUM OR HYDROGEN

(71) Applicants: AIR LIQUIDE ADVANCED TECHNOLOGIES U.S. LLC, Houston, TX (US); L'Air Liquide, Societe Anonyme pour l'Etude et l’Exploitation des Procedes Georges Claude, Paris (FR)

(72) Inventors: Paul TERRIEN, Houston, TX (US); Pierre-Philippe GUERIF, Houston, TX (US)

(21) Appl. No.: 19/574,699

(22) Filed: Mar. 23, 2026

Related U.S. Application Data
(63) Continuation of application No. 17/972,142, filed on Oct. 24, 2022.

(51) Int. Cl. C01B 23/00; B01D 53/047; B01D 53/22; C01B 3/508; C01B 3/58

(52) U.S. Cl. CPC C01B 23/0094; B01D 53/047; B01D 53/229; C01B 3/508; C01B 3/58; B01D 2256/16; B01D 2256/18; B01D 2259/40001; B01D 2259/4525; C01B 23/0052; C01B 2203/0405; C01B 2203/043; C01B 2203/0435; C01B 2210/0004; C01B 2210/001; C01B 2210/0014; C01B 2210/0031; C01B 2210/0053

(57) ABSTRACT

A method of purifying a gas composed of a product gas and one or more impurity gases including combining a feed stream with a second stream thereby forming a combined feed stream, introducing the combined feed stream into a pressure swing adsorption device, thereby producing a high purity product gas stream and an off-gas stream, and introducing the off-gas stream into a membrane separation device, thereby producing a gas stream lean in product gas and a permeate stream.

### CROSS REFERENCE TO RELATED APPLICATIONS

The present application is a continuation application of U.S. application Ser. No. 17/972,142 filed Oct. 24, 2022, which is being incorporated by reference herein in its entirety for all purposes.

### BACKGROUND

Helium is a very valuable molecule present generally in very small amounts in natural mixtures of gases, such as natural gas extracted from oil and gas fields. In order to use it, it has to be separated and purified from the mixture containing it to a degree of purity varying depending of the application. Purification can be achieved through various industrial processes ranging from cryogenic processes to adsorption and membrane separation. The prior art does not provide an efficient solution to purify a stream with a high concentration of helium to start with and even less how to optimize said purification in the presence of a second stream with a lower helium content as opposed to the first one.

This invention relates to one such method of helium purification using Pressure Swing Adsorption (PSA) process, in particular from a stream with a significant helium content to start with but to be purified to a very high quality. This invention also extends to hydrogen purification.

### SUMMARY

A method of purifying a gas composed of a product gas and one or more impurity gases including combining a feed stream with a second stream thereby forming a combined feed stream, introducing the combined feed stream into a pressure swing adsorption device, thereby producing a high purity product gas stream and an off-gas stream, and introducing the off-gas stream into a membrane separation device, thereby producing a gas stream lean in product gas and a permeate stream.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a process scheme, in accordance with one embodiment of the present invention.

FIG. 2 is another schematic representation of a process scheme, in accordance with one embodiment of the present invention.

FIG. 3 is another schematic representation of a process scheme, in accordance with one embodiment of the present invention.

FIG. 4 is another schematic representation of a process scheme, in accordance with one embodiment of the present invention.

### ELEMENT NUMBERS

101=raw helium feed stream
102=membrane feed compressor
103=compressed membrane feed stream
104=membrane unit
105=high-pressure helium-lean residue stream
106=low-pressure helium-enriched permeate stream
107=permeate stream compressor
108=pressurized permeate stream
109=first pressure swing adsorption unit
110=first catalytic oxidation unit
111=first oxygen-containing stream
112=first oxidized stream
113=helium-rich gas stream
114=first low-pressure off-gas stream
115=purified helium feed stream
116=helium-rich mixed gas stream
117=second pressure swing adsorption unit
118=second catalytic oxidation unit
119=second oxygen-containing stream
120=second oxidized stream
121=high-purity helium stream
122=second low-pressure off-gas stream
301=first fraction (of helium-rich mixed gas stream)
302=second fraction (of helium-rich mixed gas stream)
303=third pressure swing adsorption unit
304=first high-purity helium stream
305=third low-pressure off-gas
306=off-gas compressor
307=compressed off-gas stream
308=first fraction (of second oxidized stream)
309=second fraction (of second oxidized stream)
310=second-high purity helium stream
401=first catalytic oxidation unit
402=first oxygen-containing stream
403=first oxidized stream
404=combined pressure swing adsorption unit feed stream
405=first pressure swing adsorption unit
406=first low-pressure off-gas stream
407=helium-rich gas stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

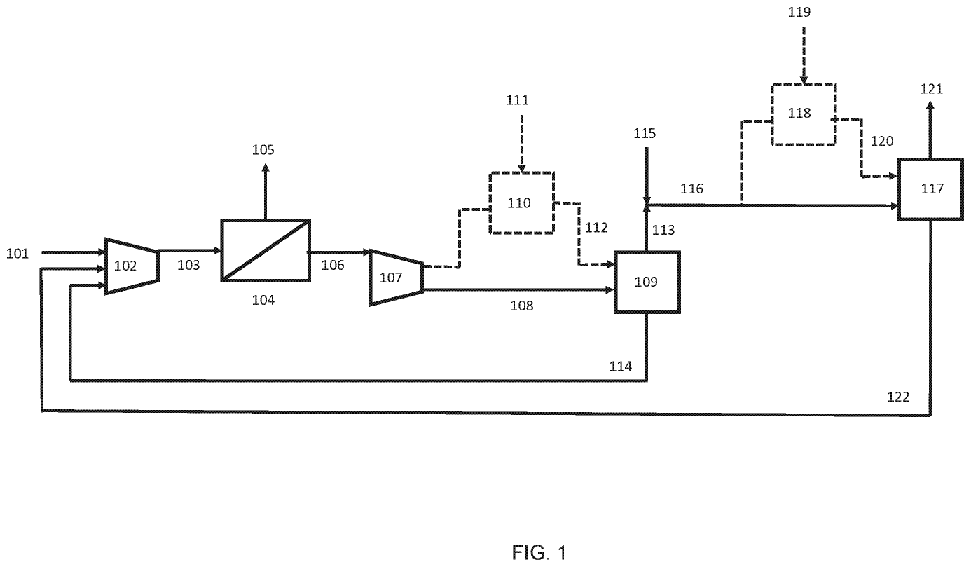

Turning now to FIG. 1, a first embodiment of the present invention that may be utilized when raw helium feed stream 101 and purified helium feed stream 115 are available. Raw helium feed stream 101, first low-pressure off-gas stream 114, and second low-pressure off-gas stream 122 are increased in pressure in membrane feed compressor 102, thereby producing compressed membrane feed stream 103. Compressed membrane feed stream 103 is then fed into membrane unit 104, thereby producing high-pressure helium-lean residue stream 105 and low-pressure helium-enriched permeate stream 106. Low-pressure helium-enriched permeate stream 106 is then increased in pressure in permeate stream compressor 107, thereby producing pressurized permeate stream 108.

Pressurized permeate stream 108 may then be introduced directly into first pressure swing adsorption unit 109. Optionally, pressurized permeate stream 108 may be introduced into first catalytic oxidation unit 110 along with first oxygen-containing stream 111, thereby producing first oxidized stream 112. First oxidized stream 112 is then introduced into first pressure swing adsorption unit 109. First pressure swing adsorption unit 109 thereby produces helium-rich gas stream 113 and first low-pressure off-gas stream 114.

Helium-rich gas stream 113 is combined with purified helium feed 115, thereby producing helium-rich mixed gas stream 116. Helium-rich mixed gas stream 116 may then be introduced directly into second pressure swing adsorption unit 117. Optionally, helium-rich mixed gas stream 116 may be introduced into second catalytic oxidation unit 118 along with second oxygen-containing stream 119, thereby producing second oxidized stream 120. Second oxidized stream 120 is then introduced into second pressure swing adsorption unit 117. Second pressure swing adsorption unit 117 thereby produces high-purity helium stream 121 and second low-pressure off-gas stream 122. Second low-pressure off-gas stream 122 is then recycled into an intake of membrane feed compressor 102.

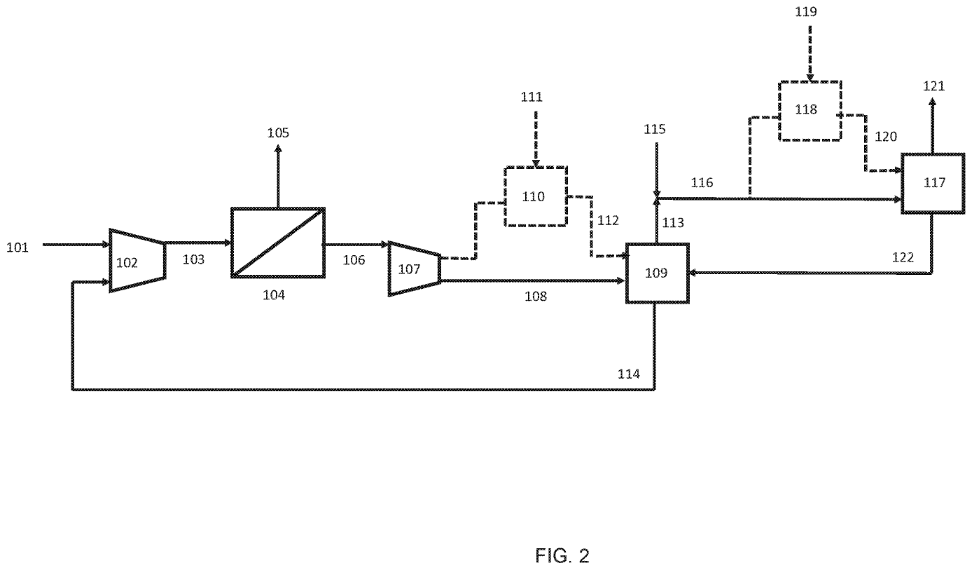

Turning now to FIG. 2, another embodiment of the present invention that may be utilized when raw helium feed stream 101 and purified helium feed stream 115 are available. Raw helium feed stream 101 and first low-pressure off-gas stream 114 are increased in pressure in membrane feed compressor 102, thereby producing compressed membrane feed stream 103. Compressed membrane feed stream 103 is then fed into membrane unit 104, thereby producing high-pressure helium-lean residue stream 105 and low-pressure helium-enriched permeate stream 106. Low-pressure helium-enriched permeate stream 106 is then increased in pressure in permeate stream compressor 107, thereby producing pressurized permeate stream 108.

Pressurized permeate stream 108 may be combined with second low-pressure off-gas stream 122 and then be introduced directly into first pressure swing adsorption unit 109. Optionally, pressurized permeate stream 108 may be introduced into first catalytic oxidation unit 110 along with first oxygen-containing stream 111, thereby producing first oxidized stream 112. First oxidized stream 112 may be combined with second low-pressure off-gas stream 122 and then introduced into first pressure swing adsorption unit 109. First pressure swing adsorption unit 109 thereby produces helium-rich gas stream 113 and first low-pressure off-gas stream 114.

Helium-rich gas stream 113 is combined with purified helium feed 115, thereby producing helium-rich mixed gas stream 116. Helium-rich mixed gas stream 116 may then be introduced directly into second pressure swing adsorption unit 117. Optionally, helium-rich mixed gas stream 116 may be introduced into second catalytic oxidation unit 118 along with second oxygen-containing stream 119, thereby producing second oxidized stream 120. Second oxidized stream 120 is then introduced into second pressure swing adsorption unit 117. Second pressure swing adsorption unit 117 thereby produces high-purity helium stream 121 and second low-pressure off-gas stream 122. Second low-pressure off-gas stream 122 is then recycled into an intake of first pressure swing adsorption unit 109.

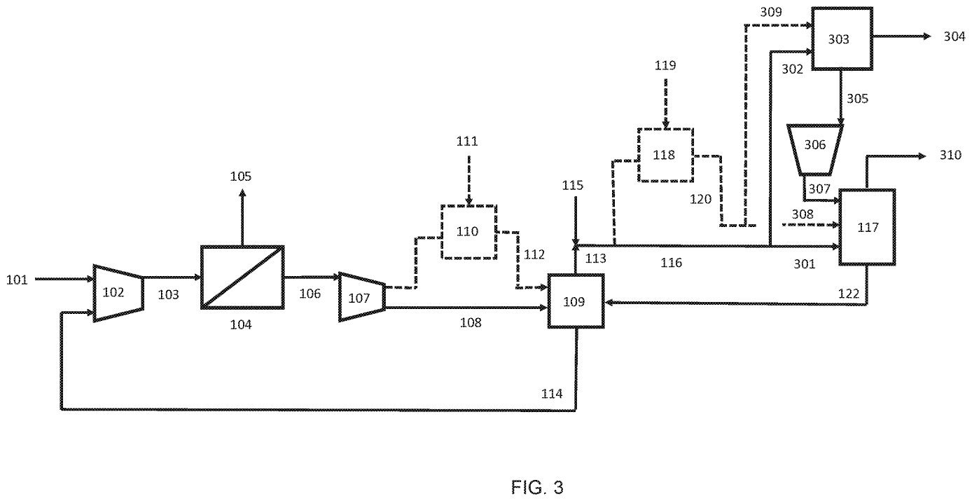

Turning now to FIG. 3, another embodiment of the present invention that may be utilized when raw helium feed stream 101 and purified helium feed stream 115 are available. Raw helium feed stream 101 and first low-pressure off-gas stream 114 are increased in pressure in membrane feed compressor 102, thereby producing compressed membrane feed stream 103. Compressed membrane feed stream 103 is then fed into membrane unit 104, thereby producing high-pressure helium-lean residue stream 105 and low-pressure helium-enriched permeate stream 106. Low-pressure helium-enriched permeate stream 106 is then increased in pressure in permeate stream compressor 107, thereby producing pressurized permeate stream 108.

Pressurized permeate stream 108 may be combined with second low-pressure off-gas stream 122 and then be introduced directly into first pressure swing adsorption unit 109. Optionally, pressurized permeate stream 108 may be introduced into first catalytic oxidation unit 110 along with first oxygen-containing stream 111, thereby producing first oxidized stream 112. First oxidized stream 112 may be combined with second low-pressure off-gas stream 122 and then introduced into first pressure swing adsorption unit 109. First pressure swing adsorption unit 109 thereby produces helium-rich gas stream 113 and first low-pressure off-gas stream 114.

Helium-rich gas stream 113 is combined with purified helium feed 115, thereby producing helium-rich mixed gas stream 116. Helium-rich mixed gas stream 116 is split into two fractions. First fraction 301 may then be introduced directly into second pressure swing adsorption unit 117. Second fraction 302 is fed into third pressure swing adsorption unit 303. Third pressure swing adsorption unit 303 thereby produces first high purity helium stream 304 and third low-pressure off-gas stream 305. Third low-pressure off-gas stream 305 is compressed in off-gas compressor 306 and then compressed off-gas stream 307 is introduced into second pressure swing adsorption unit 117.

Optionally, helium-rich mixed gas stream 116 may be introduced into second catalytic oxidation unit 118 along with second oxygen-containing stream 119, thereby producing second oxidized stream 120.

Second oxidized stream 120 may be split into two fractions. First fraction 308 may then be introduced directly into second pressure swing adsorption unit 117. Second fraction 309 is fed into third pressure swing adsorption unit 303. Third pressure swing adsorption unit 303 thereby produces first high purity helium stream 304 and third low-pressure off-gas stream 305. Third low-pressure off-gas stream 305 is compressed in off-gas compressor 306 and then compressed off-gas stream 307 is introduced into second pressure swing adsorption unit 117. Second pressure swing adsorption unit 117 thereby produces second high-purity helium stream 310 and second low-pressure off-gas stream 122.

The system presented in FIG. 3 would be useful, for example, in situations where a helium liquefier facility is sufficiently close by. Wherein the feed may come from a pressurized gas storage thank that is filled by, for example, high pressure tube trailers. In such a case, the feed gas would typically contain 95-99% mol helium and the target product for the liquefaction would need to be greater than 99.9% helium. In such a situation, it would be possible for membrane unit 104, first PSA 109 and second PSA 117 to be part of an existing plant, and third PSA 303 is a new, purpose built PSA intended to handle the additional capacity.

It is noted that overall, the process schemes shown in FIGS. 1-3 offer similar solutions to the industry. If second PSA 117 is part of an existing system, and this second PSA is sufficient to manage the extra helium from, for example, tube trailers, then the systems indicated in either FIG. 1 or FIG. 2 may be appropriate. If, however, this additional helium exceeds the capacity of the existing second PSA, then the system indicated in FIG. 3 may be more appropriate.

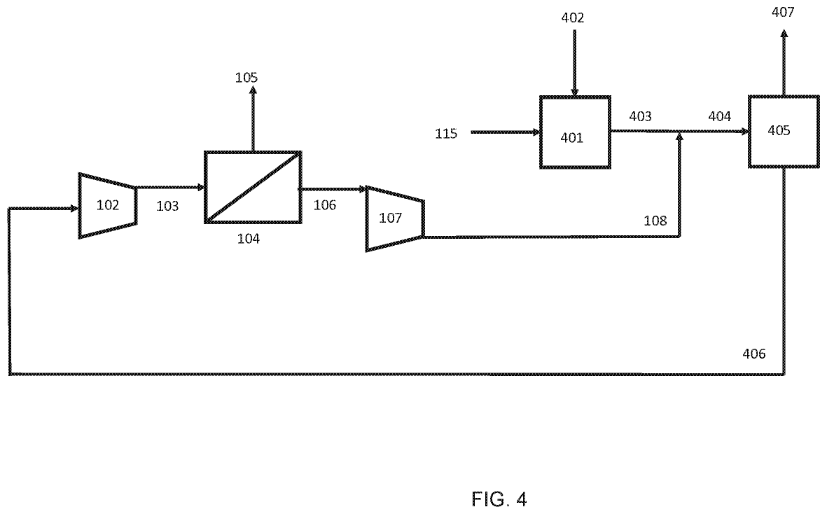

Turning now to FIG. 4, another embodiment of the present invention that may be utilized when no raw helium feed stream 101 is available.

Purified helium feed 115 and first oxygen-containing stream 402 are introduced into first catalytic oxidation unit 401 thereby producing first oxidized stream 403. First oxidized stream 403 is combined with pressurized permeate stream 108, and combined pressure swing adsorption unit feed stream 404 is introduced into first pressure swing adsorption unit 405. First pressure swing adsorption unit 405 thereby produces helium-rich gas stream 407 and first low-pressure off-gas stream 406.

First low-pressure off-gas stream 406 is increased in pressure in membrane feed compressor 102, thereby producing compressed membrane feed stream 103. Compressed membrane feed stream 103 is then fed into membrane unit 104, thereby producing high-pressure helium-lean residue stream 105 and low-pressure helium-enriched permeate stream 106. Low-pressure helium-enriched permeate stream 106 is then increased in pressure in permeate stream compressor 107, thereby producing pressurized permeate stream 108.

It is noted that the system presented in FIG. 4 would be useful, for example, in situations where a helium liquefier facility is sufficiently close by. Wherein the feed may come from a pressurized gas storage thank that is filled by, for example, high pressure tube trailers. In such a case, the feed gas would typically contain 95-99% mol helium and the target product for the liquefaction would need to be greater than 99.9% helium.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method of purifying helium from natural gas (101), the method comprising:
a) providing a first gas stream (103) having a first concentration of helium,
b) performing a permeation separation by a membrane separation unit (104) on the first gas stream to form
a retentate gas having a lower helium concentration than the first gas (105), and
a permeate gas having a higher helium concentration than the first gas (106),
c) providing the permeate gas (106) to a first pressure swing adsorption (PSA) unit (109) and performing a pressure swing adsorption separation of the permeate gas to form
a first PSA product gas stream having a higher helium concentration than the permeate gas (113), and
a first PSA tail gas stream having a lower helium concentration than the permeate gas (114),
d) adding an externally sourced helium containing stream (115), having a higher concentration of helium than the first PSA product gas stream, to the first PSA product gas stream (113) to produce a mixed gas stream having a higher helium concentration than the first PSA product gas stream (116),
e) providing the mixed gas stream (116) to a second PSA unit (117) and performing a pressure swing adsorption separation of the mixed gas stream to form
a final helium product stream having a higher helium concentration than the mixed gas stream (121), and
a second PSA tail gas stream having a lower helium concentration than the mixed gas stream (122),
f) recycling the first PSA tail gas stream (114) into the natural gas stream (101) to form the first gas stream (103), and
g) recycling the second PSA tail gas stream (122)
into the natural gas stream (101) to form the first gas stream (103), or
into the first PSA unit (109) for a pressure swing adsorption separation of the second PSA tail gas stream.

2. The method of claim 1, wherein step g) comprises recycling the second PSA tail gas stream (122) into the natural gas stream (101) to form the first gas stream (103).

3. The method of claim 1, wherein step g) comprises recycling the second PSA tail gas stream (122) into the first PSA unit (109) for a pressure swing adsorption separation of the second PSA tail gas stream.

4. The method of claim 2, further comprising, after step b), introducing the permeate gas (106) having the higher helium concentration than the first gas along with an oxygen-containing stream (111) into a catalytic oxidation unit (110), thereby producing an oxidized permeate gas (112), and performing step c) on the oxidized permeate gas.

5. The method of claim 2, further comprising, after step d), introducing the mixed gas stream (116) along with a second oxygen-containing stream (119) into a second catalytic oxidation unit (118), thereby producing an oxidized mixed gas stream (120), and performing step e) on the oxidized mixed gas stream.

6. The method of claim 3, further comprising, after step b), introducing the permeate gas (106) having the higher helium concentration than the first gas along with an oxygen-containing stream (111) into a catalytic oxidation unit (110), thereby producing an oxidized permeate gas (112), and performing step c) on the oxidized permeate gas.

7. The method of claim 3, further comprising, after step d), introducing the permeate gas (106) having the higher helium concentration than the first gas along with an oxygen-containing stream (111) into a catalytic oxidation unit (110), thereby producing an oxidized permeate gas (112), and performing step c) on the oxidized permeate gas.

8. The method of claim 1, further comprising the steps of:
h) after step d), providing a portion of the mixed gas stream (302) to a third PSA unit (303) and performing a pressure swing adsorption separation of the portion of the mixed gas stream to form
an additional final helium product stream having a higher helium concentration than the mixed gas stream (304), and
a third PSA tail gas stream having a lower helium concentration than the mixed gas stream (305), and
i) recycling the third PSA tail gas stream (305) into the second PSA unit (117) for a pressure swing adsorption separation concurrently with step e).

9. The method of claim 8, further comprising, after step b), introducing the permeate gas (106) having the higher helium concentration than the first gas along with an oxygen-containing stream (111) into a catalytic oxidation unit (110), thereby producing an oxidized permeate gas (112), and performing step c) on the oxidized permeate gas.

10. The method of claim 8, further comprising, after step d), introducing the mixed gas stream (116) along with a second oxygen-containing stream (119) into a second catalytic oxidation unit (118), thereby producing an oxidized mixed gas stream (120), and performing step e) on the oxidized mixed gas stream.

11. The method of claim 8, wherein step g) comprises recycling the second PSA tail gas stream (122) into the natural gas stream (101) to form the first gas stream (103).

12. The method of claim 8, wherein step g) comprises recycling the second PSA tail gas stream (122) into the first PSA unit (109) for a pressure swing adsorption separation of the second PSA tail gas stream.
